(19) United States
(12) Patent Application Publication
(10) Pub. No.: US 2008/0228634 A1
(43) Pub. Date: Sep. 18, 2008

(54) Loan structure with tax benefits

(76) Inventor: Tony Unwin, Orlando, FL (US)

Correspondence Address: FURR LAW FIRM, 2622 DEBOLT ROAD, UTICA, OH, 43080, US

(21) Appl. No.: 11/686,940

(22) Filed: Mar. 15, 2007

(51) Int. Cl. G06Q 40/00

(52) U.S. Cl. 705/38

(57) ABSTRACT

The current invention is a system, method and program of making loans with tax benefits. Instead of a conventional loan note, or mortgage the financer takes a portion of equity in the company (this may, or may not hold real estate). This has the advantage of not being a formal 2^{nd} mortgage, as this is often forbidden by a primary financer (though it can be secured by a lien on an asset) in addition to the ownership of stock. This is often called an “assignment of partnership interest”. The gradual payments to the financer of interest and principal perform much like a loan note, however payments have the advantage of technically being dividends rather than interest, so are taxed at a lower rate.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of loans, more particular loans with tax benefits.

2. Background

Investors in commercial real estate are looking on how to put together deals with low or no down payments. This is easier when putting together an offer where both parties benefit. Many sellers or providers of secondary financing will either not wish to provide financing, or will do so on poor terms. There exists a need to find a way to sweeten the deal.

3. Prior Art

U.S. Pat. No. 5,644,726 by Oppenheimer and issued on Jul. 1, 1997 is for a method and system implementing a mortgage partnership. It discloses a process of and method for financing purchase of real property by mortgagors through a combination of mortgagee debt principal and partial mortgagee equity interest in the purchased property by a system which both calculates multiple mortgagor financial obligations and mortgagee rights and which prints instruments embodying those obligations and rights. The system also employs generally available house price indices as proxies for equity values, produces periodic reports to mortgagors of obligated balances, and determines mortgagee and mortgagor balances upon sale and/or termination of instruments produced by the system. This enables the creation of a loan that is a hybrid of equity and debt. Our invention differs from it in that the financer is repaid by the end of the loan term, receiving no equity “kicker”. They also enjoy the benefits of the tax pass throughs.

U.S. Pat. No. 6,345,262 by Madden and issued on Feb. 5, 2002 is for a system and method for implementing a mortgage plan. It discloses a system and method for implementing a mortgage plan. Data is input to a computer system regarding the mortgage terms, and the computer system is used to prepare a mortgage document which creates an equity participation mortgage obligation in which the financer shares in a predetermined percentage of realized appreciation on the subsequent sale of the asset which is the subject of the mortgage. In a particularly preferred embodiment, this mortgage plan can provide the borrower with an interest-free loan, a faster amortization schedule, and a larger, yet more affordable mortgage. The financer also receives substantial benefits, including the potential for a return which exceeds conventional mortgage rate returns, insulation from risk against interest rate fluctuation, and preferred tax treatment in the form of capital gains tax rates paid only upon the subsequent sale of the mortgaged asset. No maturity date need be specified for the mortgage; rather, it may be tied to the ultimate sale of the asset subject to the mortgage.

This enables the creation of a loan that is a hybrid of equity and debt. The current invention differs from it in that the financer is repaid by the end of the loan term, receiving no equity “kicker”. They also enjoy the benefits of the tax pass throughs.

There is still room for improvement in the art.

### SUMMARY OF THE INVENTION

The current invention is a system, method and program of making loans with tax benefits. Instead of a conventional loan note, or mortgage the financer takes a portion of equity in the company (this may, or may not hold real estate). This has the advantage of not being a formal 2^{nd} mortgage, as this is often forbidden by a primary financer (though it can be secured by a lien on an asset) in addition to the ownership of stock. This is often called an “assignment of partnership interest”. The gradual payments to the financer of interest and principal perform much like a loan note, however payments have the advantage of technically being dividends rather than interest, so are taxed at a lower rate.

### BRIEF DESCRIPTION OF THE DRAWINGS

Without restricting the full scope of this invention, the preferred form of this invention is illustrated in the following drawings:

FIG. 1 is a schematic block diagram of a conceptualized operation of the present invention; and

FIG. 2 is a block diagram showing a basic arrangement of a computer system that can run the current invention.

### BRIEF DESCRIPTION OF THE PREFERRED EMBODIMENTS

There are a number of significant design features and improvements incorporated within the invention.

The current invention is a system, method and program of making loans with tax benefits. Instead of a conventional loan note, or mortgage the financer takes a portion of equity in the company (this may, or may not hold real estate). This has the advantage of not being a formal 2^{nd} mortgage, as this is often forbidden by a primary financer (though it can be secured by a lien on an asset) in addition to the ownership of stock. This is often called an “assignment of partnership interest”. The gradual payments to the financer of interest and principal perform much like a loan note, however payments have the advantage of technically being dividends rather than interest, so are taxed at a lower rate.

The current invention supersedes this practice by also assigning the entities tax benefits to the financer during the time that they own shares in it. It is not always necessary for profits or benefits to flow through an entity evenly according to the owner's shareholding. The borrower often has less need of tax benefits than the financer, so can assign them to the financer/financer. This provides an added incentive for them to make the loan and enables them to do so at better terms.

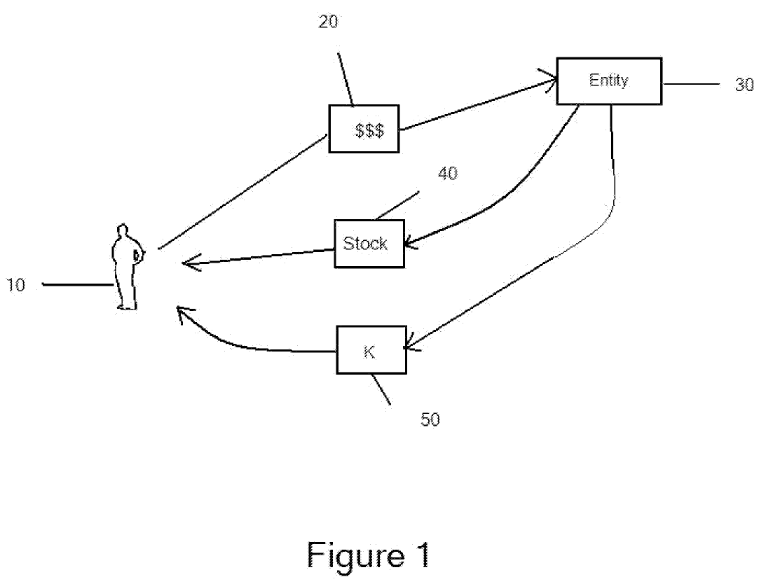

As shown in FIG. 1, the financer 10 provides funds 20 to the borrowing entity 30. The financer 10 takes an equity interest 40 such as shares in the borrowing entity 30. An agreement 50 states the time period over which the financer 10 will be brought out and for how much they will be bought out. The entity 30 will buy back the equity interest 40 This acts very much like a loan note. The entity 30 assigns all, or part of the tax benefits it receives to the financer 10.

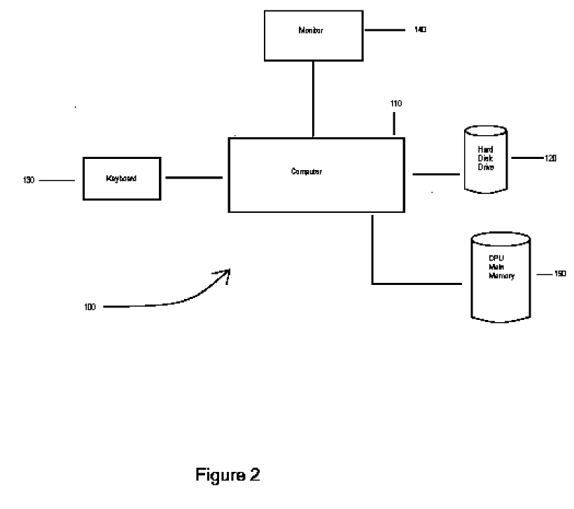

The system 1 can be set up to be run a on a computing device. FIG. 2 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

### Advantages

The advantages of this are as follows. This is not a formal 2^{nd} mortgage and can therefore get around restrictive primary financer covenants. Payments are taxed as dividends, not interest and therefore receive preferential treatment. The investor can share a greater proportion, or all, of the tax benefits generated by the entity, including all the depreciation on any assets it might have. These benefits are considerably greater than the small part of the purchase being financed. The greatly increased tax benefits can enable a financer to lend where it previously may not have been able to and at more advantageous rates.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having a financer provide funds to an entity in exchange of for an equity interest in said entity where the entity will buy back said interest over a period of time.

2. The method as defined in claim 1, wherein an agreement is signed between the financer and the entity.

3. The method as defined in claim 2, where said agreement sets the buy back terms between the financer and the entity.

4. The method as defined in claim 1, where said entity assign all or the tax benefits to said financer.

5. The system as defined in claim 1, where said system is running on a computer processing device.

6. A method comprising the steps: having a financer provide funds to an entity in exchange of for an equity interest in said entity where the entity will buy back said interest over a period of time, where an agreement is signed between the financer and the entity where said agreement sets the buy back terms between the financer and the entity and where said entity assign all or the tax benefits to said financer.

7. The system as defined in claim 1, where said system is running on a computer processing device.
